(19) United States
(12) Patent Application Publication
(10) Pub. No.: US 2004/0045029 A1
(43) Pub. Date: Mar. 4, 2004

(54) Apparatus, system and method for multicasting digital data, and program for implementing multicast delivery

(75) Inventor: Noritaka Matsuura, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/651,995

(22) Filed: Sep. 2, 2003

(30) Foreign Application Priority Data
Sep. 4, 2002 (JP) 2002-258360

(51) Int. Cl. H04N 7/173; G06F 15/16

(52) U.S. Cl. 725/93; 709/219

(57) ABSTRACT

A multicast controller capable of delivering moving image and music data, comprises delivery content announcing means 11 for announcing delivered contents, a reception fee, and a scheduled delivery start time to each of cells A, B; decryption key delivering means 12 for delivering a decryption key for decrypting encrypted data to reception wishing users; user number counting means 13 for counting the number of reception wishing users in each of cells A, B; delivery condition determining means 14 for determining whether or not each cell satisfies a previously set delivery condition; and data delivering means 15 for multicasting the moving image and music data to a cell which satisfies the delivery condition.

### BACKGROUND OF THE INVENTION

(1) Field of the Invention

The present invention relates to an apparatus, system and method for multicasting digital data such as moving images, music and the like through the Internet. The present invention also relates to a program for implementing such multicast delivery.

(2) Description of the Related Art

In recent years, services have been provided for delivering digital data such as moving images, music and the like to users through the Internet. The multicast delivery is highly effective because of its ability to simultaneously deliver data to a plurality of users, but it has not yet been generally used in practice due to the fact that there is not a serious problem associated with the bandwidth in Internet-based delivery services.

Recently, a commercial system has been brought into practical use for delivering moving image and music data at cost from a server within a 3G (third generation) network or on the Internet to subscriber terminals (mobile terminals) of the 3G network. In another system, as a user sends a delivery request to a server which preserves data, the server responsively starts delivering the data in real time, irrespective of a streaming form or a file download form. Since data is typically encrypted in this data delivery, the user should receive a decryption key prior to the data delivery.

The foregoing systems entail communication expenses in addition to charges for contents. Since the delivery of moving image and music data requires a large amount of data, the communication expenses, particularly, user's fee for wireless sections are so high that the demand for such systems may not be increased in some cases. When the multicast delivery is utilized in such a case, the communication expenses can be limited, so that an increase in the demand is expected. A multicast delivery system for moving image and music data involves a delivery server which previously announces delivered contents and a scheduled delivery start time, and a reception wishing user who reserves the delivery to receive moving image and music data from the scheduled delivery start time, as a pay-per-view system in the CS (Communication Satellite) broadcasting (see JP-A-2002-15215, 2001-223732, and 2001-290722).

For applying the multicast delivery system to a cellular scheme such as the aforementioned 3G network, data is delivered only to cells in which reception wishing users are present. However, since users can move from one cell to another, the users must be located before delivering data. For locating a user to deliver data to him, a multicast controller, for example, communicates with a management server which manages the position of each user at a scheduled delivery start time, performs paging, and delivers data to cells in which the users are present. In an alternative to the foregoing, a reception wishing user may set a connection with a multicast controller at or before a scheduled delivery start time.

However, the multicast delivery system as mentioned above has a problem of prohibitively high use fees in wireless sections when there are few reception wishing users within a cell. For example, assuming that a reception fee C is charged when data is unicasted to a single cell, and a reception fee for multicasting data to the single cell is set at C/5, the multicast delivery will make a profit if there are five or more reception wishing users in each cell, whereas the multicast delivery will produces losses if there are less than five users within each cell. Conventionally, since data is delivered even to a cell in which there are less than five users in the latter case, losses are inevitably produced, resulting in higher reception fees which cause larger burdens on the users.

### SUMMARY OF THE INVENTION

It is an object of the present invention to provide a multicast controller, a multicast delivery system, a multicast delivery method which can solve the problems mentioned above and multicast moving image and music data at small charges, and a program for implementing such multicasting.

To achieve the above object, a multicast controller according to the present invention is provided for multicating moving image and music data supplied from a delivery server to a plurality of user terminals in a plurality of cells each defining a communication area, characterized by comprising utilization information acquiring means for acquiring information on reception and utilization of the moving image and music data for one of the cells which contains the plurality of user terminals, based on a request received from each of the plurality of user terminals for delivering the moving image and music data, delivery condition determining means for determining whether or not a previously set delivery condition is satisfied based on the reception and utilization information acquired by the utilization information acquiring means, and data delivering means for multicasting the moving image and music data only to a cell which satisfies the delivery condition. In the multicast controller, the utilization information acquiring means may be means for counting the number of users who wish to receive the moving image and music data for the sell which contains the plurality of user terminals. Alternatively, the utilization information acquiring means may be means for measuring a total of reception fees set by users who wish to receive the moving image and music data for the cell which contains the plurality of user terminals.

According to the multicast controller of the present invention as described above, the controller relies on requests for receiving moving image and music data from a plurality of user terminals to identify cells in which these user terminals are situated, and measures reception and utilization information for the moving image and music data, for example, the number of reception wishing users, and a total of reception fees. Then, the controller determines based on the result of the measurements whether or not each cell satisfies a previously set delivery condition, and multicasts data only to cells which satisfy the delivery condition. A cell which satisfies the delivery condition may be, for example, a cell in which there are five or more reception wishing users, or a cell which can ensure a reception fee “C” in the aforementioned case where a reception fee for multicasting data to the single cell is set at C/5. In this way, a profit is ensured by the multicast delivery. Consequently, the multicast controller according to the present invention can deliver moving image and music data at a lower charge than not only the unicast system but also a conventional multicast system which multicasts data to all cells in which reception wishing users exist.

A multicast delivery system according to the present invention is characterized by having a delivery server for delivering moving image and music data, a plurality of user terminals contained in any of a plurality of cells, and a multicast controller for multicasting the moving image and music data supplied from the delivery server to the plurality of user terminals, wherein the multicast controller includes utilization information acquiring means for acquiring information on reception and utilization of the moving image and music data for one of the cells which contains the plurality of user terminals, based on a request received from each of the plurality of user terminals for delivering the moving image and music data, delivery condition determining means for determining whether or not a previously set delivery condition is satisfied based on the reception and utilization information acquired by the utilization information acquiring means, and data delivering means for multicasting the moving image and music data only to a cell which satisfies the delivery condition.

A multicast delivery method according to the present invention is provided for multicating moving image and music data supplied from a delivery server to a plurality of user terminals in a plurality of cells each defining a communication area, characterized by including the first step of acquiring information on reception and utilization of the moving image and music data for one of the cells which contains the plurality of user terminals, based on a request received from each of the plurality of user terminals for delivering the moving image and music data, the second step of determining whether or not a previously set delivery condition is satisfied based on the reception and utilization information acquired at the first step, and the third step of multicasting the moving image and music data only to a cell which satisfies the delivery condition.

A program according to the present invention is provided for use in a multicast controller for multicating moving image and music data supplied from a delivery server to a plurality of user terminals in a plurality of cells each defining a communication area, characterized by causing a computer of the multicast controller to execute first processing for acquiring information on reception and utilization of the moving image and music data for one of the cells which contains the plurality of user terminals, based on a request received from each of the plurality of user terminals for delivering the moving image and music data, second processing for determining whether or not a previously set delivery condition is satisfied based on the reception and utilization information acquired by the first processing, and third processing for multicasting the moving image and music data only to a cell which satisfies the delivery condition.

The foregoing multicast delivery system, multicast delivery method, and program can each provide similar advantageous effects to those of the multicast controller according to the present invention.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram illustrating the configuration of a multicast delivery system according to one embodiment of the present invention;

FIG. 2 is a block diagram illustrating an exemplary configuration of a multicast controller shown in FIG. 1;

FIG. 3 is a sequence chart showing the operation of the multicast delivery system illustrated in FIG. 1;

FIG. 4 is a flow chart illustrating the operation of the multicast controller illustrated in FIG. 2;

FIG. 5 is a sequence chart showing the operation of a multicast delivery system according to another embodiment of the present invention;

FIG. 6 is a flow chart illustrating the operation of a multicast controller according to the other embodiment of the present invention;

FIG. 7 is a sequence chart showing the operation of a multicast delivery system according to a further embodiment of the present invention; and

FIG. 8 is a flow chart illustrating the operation of a multicast controller according to the further embodiment of the present invention.

### DESCRIPTION OF THE PREFERRED EMBODIMENT(S)

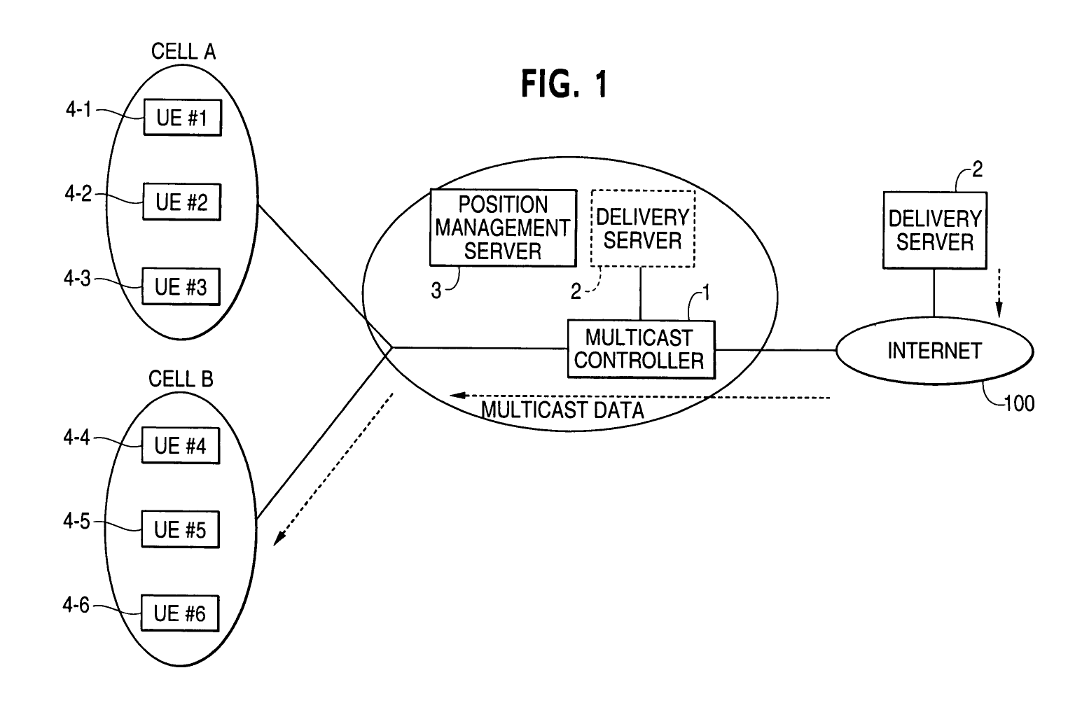

FIG. 1 is a block diagram illustrating the configuration of a multicast delivery system according to one embodiment of the present invention. The illustrated multicast delivery system, which employs a cellular scheme such as a 3G network, by way of example, comprises multicast controller 1 for multicasting moving image and music data; delivery server 2 which is the originator of the moving image and music data; user terminals [UE#1-UE#6] 4-1-4-6; and position management server 3 for managing the positions of respective user terminals (UE#1-UE#6) 4-1-406.

Multicast controller 1 is connected to delivery server 2 through Internet 100, as indicated by a solid line block in FIG. 1, or directly connected to delivery server 2 through an exclusive line, as indicated by a dotted line block in FIG. 1. Multicast controller 1 is also connected to position management server 3. User terminals (UE#1-UE#6) 4-1-4-6 are mobile terminals which can move from one cell to another, and are capable of making wireless communications within a cell. In the example illustrated in FIG. 1, user terminals (UE#1-UE#3) 4-1-4-3 are situated in cell A, while user terminals (UE#4-UE#6) 4-4-4-6 are situated in cell B. While there are only two cells A, B shown in FIG. 1 for convenience, a multiplicity of cells exist in actuality.

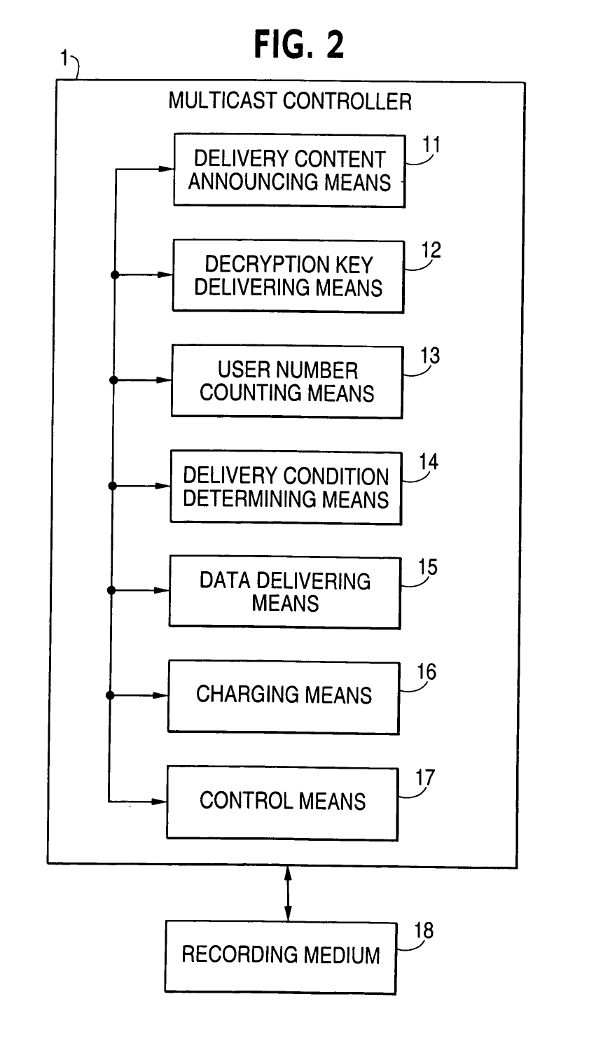

FIG. 2 is a block diagram illustrating an exemplary main configuration of multicast controller 1 shown in FIG. 1. Main components of multicast controller 1 comprises delivery content announcing means 11; decryption key delivering means 12; user number counting means 13 for acquiring use information; delivery condition determining means 14; data delivering means 15; charging means 16; control means 17; and recording medium 18. Though not shown, multicast controller 1 additionally comprises communication means for making communications with delivery server 2, position management server 3, user terminals (UE#1-UE#6) 4-1-4-6, and the respective components of multicast controller 1. Since this communication means is known, detailed description thereon is omitted here.

Delivery content announcing means 11 announces delivered contents, a reception fee, a scheduled delivery start time to each of cells A, B, where the reception fee refers to the sum of communication expenses and a charge for contents paid by a recipient. Decryption key delivering means 12 delivers a decryption key for decrypting encrypted data to reception wishing users.

User number counting means 13 counts the number of reception wishing users in each of cells A, B based on delivery reservations from user terminals (UE#1-UE#6) 4-1-4-6, and information on their positions. Delivery condition determining means 14 determines whether or not each cell satisfies a previously set delivery condition. The delivery condition is applied when moving image and music data is multicast from delivery server 2, and specifically stipulates that there are a given number of reception wishing users within a cell. Data delivering means 15 multicasts moving image and music data from delivery server 2 to a cell which is determined to satisfy the delivery condition by delivery condition determining means 14.

Charging means 16 charges a reception wishing user for the delivered contents at the start of data delivery. Recording medium 18 stores a program which can be executed on a computer. Control means 17 executes the program stored on recording medium 18 to control the respective means to implement the multicast delivery of moving image and music data.

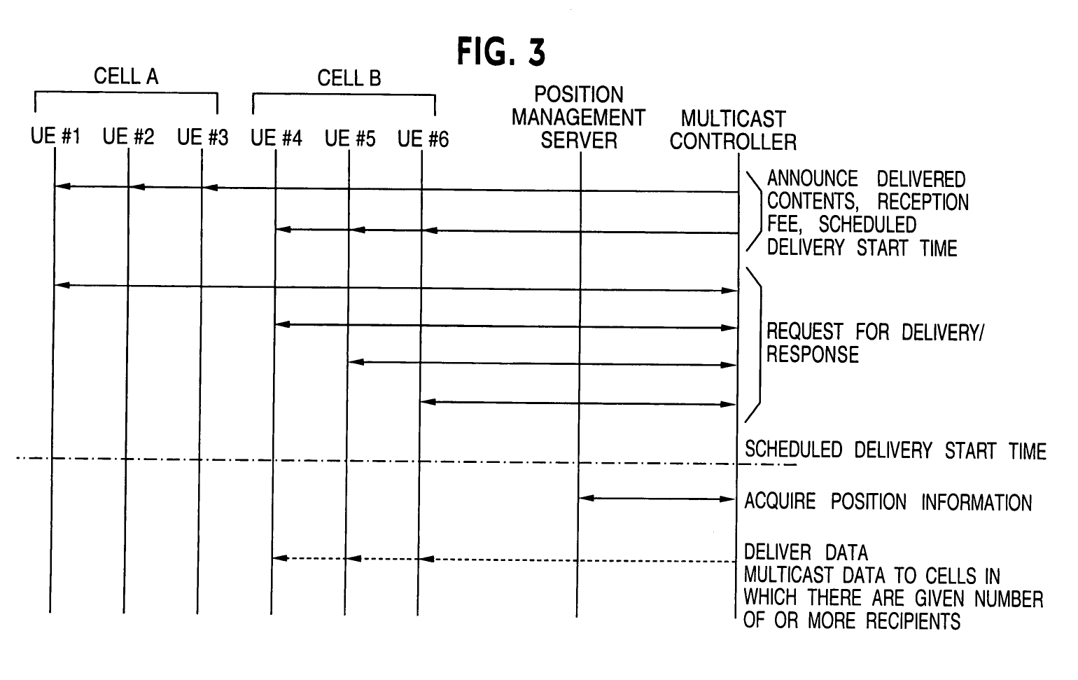

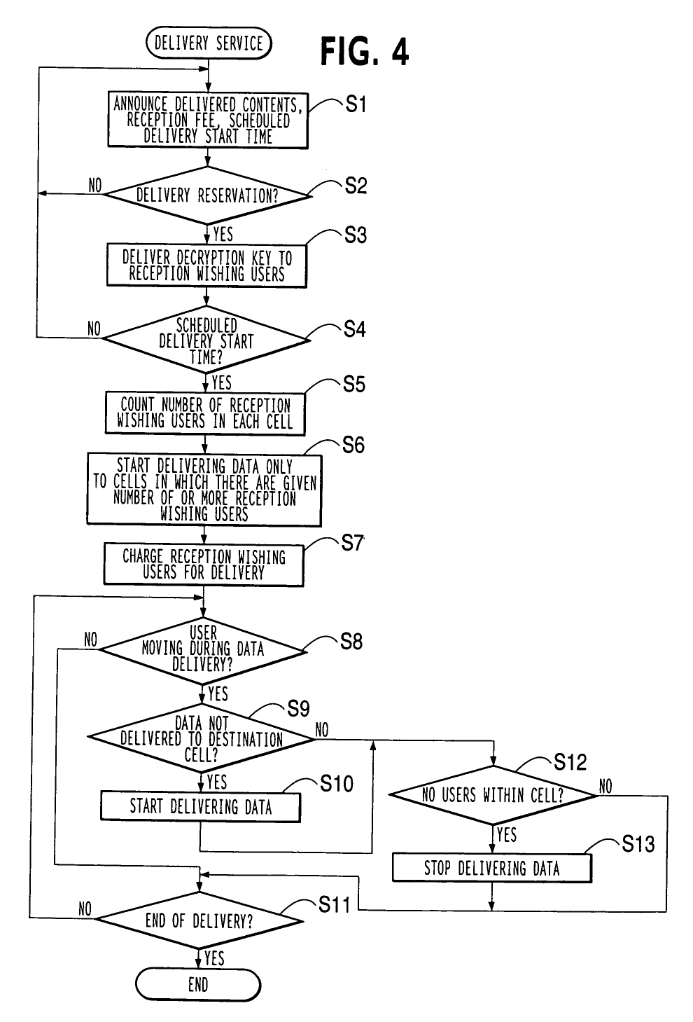

FIG. 3 is a sequence chart showing the operation of the multicast delivery system illustrated in FIG. 1, and FIG. 4 is a flow chart illustrating the operation of multicast controller 1 shown in FIG. 2. The processing illustrated in FIG. 4 is implemented by control means 17 which executes the program on recording medium 18. In the following, the delivery operation of the multicast delivery system according to this embodiment will be described with reference to FIGS. 1 to 4.

Upon start of a delivery service, multicast controller 1 announces delivered contents, a reception fee, and a scheduled delivery start time from delivery content announcing means 11 to each of cells A, B (step S1 in FIG. 4), and waits for delivery reservations from reception wishing users (step S2 in FIG. 4). Upon receipt of a delivery reservation from a reception wishing user, multicast controller 1 delivers a decryption key to the reception wishing user from decryption key delivering means 12 (step S3 in FIG. 4). In the example of FIG. 3, multicast controller 1 receives delivery reservations from user terminal (UE#1) 4-1 in cell A, and user terminals (UE#4-UE#6) 4-4-4-6 in cell B, so that the decryption key is delivered to these user terminals.

When the scheduled delivery start time is reached (step S4 in FIG. 4), multicast controller 1 communicates with position management server 3, counts the number of reception wishing users in each of cells A, B in user number counting means 13 (step S5 in FIG. 4), and starts delivering data from data delivering means 15 only to a cell in which there are a given number of reception wishing users (step S6 in FIG. 4). At the time the data delivery is started, multicast controller 1 charges reception wishing users for the contents with the aid of charging means 16 (step S7 in FIG. 4). In the example of FIG. 3, delivery condition determining means 14 determines that there are the given number of reception wishing users only in cell B, so that data is delivered to cell B.

When a user moves from a current cell to an adjacent different cell during a data delivery, a handover occurs. In the event of handover, multicast controller 1 continues the data delivery service by starting the data delivery to the destination cell if it has not delivered data to this cell (steps S8, S9, S10 in FIG. 4). When all users in a cell move to other cells and no user remains in this cell (step S12 in FIG. 4), multicast controller 1 stops delivering data to the cell (step S13). Multicast controller 1 repeats such processing associated with the handover (steps S8-S13) until the data delivery is completed.

In this embodiment as described above, for multicasting moving image and music data from delivery server 2 to a plurality of users through multicast controller 1 in a cellular based 3G network, reception wishing users first reserve the delivery. Then, multicast controller 1 communicates with position management server 3 for managing the positions of users who have reserved the delivery at a frequency according to the necessity to monitor the number of users in each of cells A, B, and starts multicasting moving image and music data only to a cell in which there are the given number of users. The given number of users, used herein, refers to the number of users with which the multicast delivery can make a profit. Specifically, when a reception fee C is charged when data is unicasted to a single cell, and a reception fee for multicasting data to the single cell is set at C/5, the given number of users is five or more. In this way, since moving image and music data is multicast only to a cell in which there are the given number of users, the multicast delivery can make a profit without fail. Consequently, moving image and music data can be delivered at a lower charge as compared with the unicast system and a conventional multicast system which multicasts data to all cells in which there are reception wishing users irrespective of the number of users within each cell. In addition, since the possibility of inexpensive delivery results in an increase in the number of users, it is advantageous for a business owner as well.

The data delivery operation performed by multicast controller 1 is directed to a streaming form. When a file download form is employed instead of the streaming form, a decryption key is delivered to users after a secure delivery of data, and the users are charged for the delivered data at the time the decryption key is delivered.

Also, while the foregoing embodiment sets the delivery condition which stipulates that there are a given number of users, the delivery condition can be modified as appropriate as long as the multicast delivery can make a profit. The followings present several exemplary variations of the delivery condition.

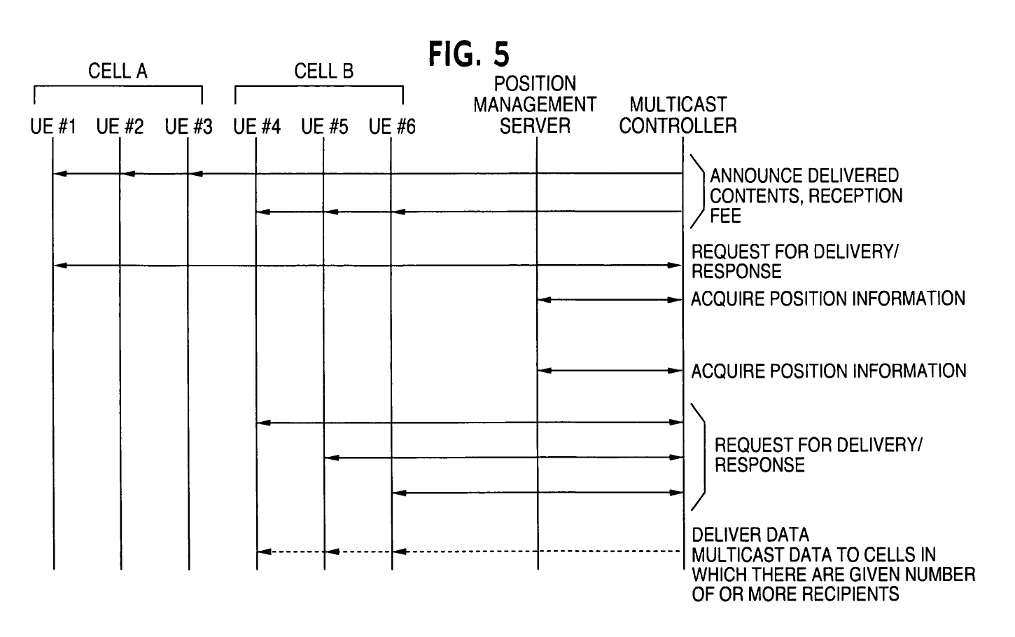

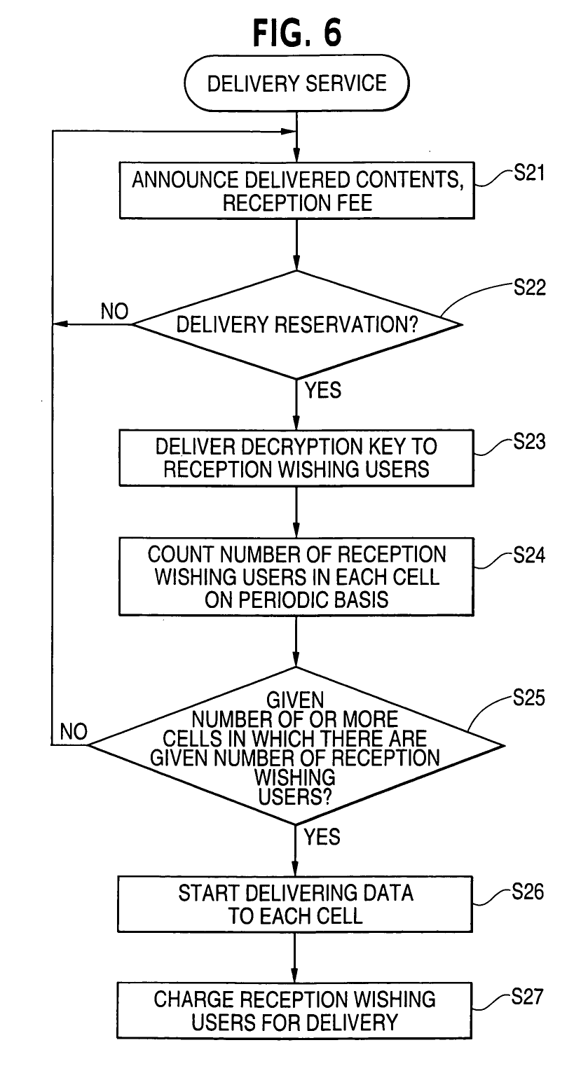

FIG. 5 is a sequence chart showing the operation of a multicast delivery system according to another embodiment of the present invention, and FIG. 6 is a flow chart illustrating the operation of a multicast controller according to the other embodiment of the present invention. Since the multicast delivery system and multicast controller are basically identical in configuration to those illustrated in FIGS. 1 and 2, the following description will focus on characteristic operations in the multicast delivery with reference to FIGS. 1, 2, 5 and 6. Likewise, in this embodiment, the processing illustrated in FIG. 6 is implemented by control means 17 which executes a program on recording medium 18.

Upon start of a delivery service, multicast controller 1 announces delivered contents and a reception fee from delivery content announcing means 11 to each of cells A, B (step S21 in FIG. 6, and “announce delivered contents and reception fee” in FIG. 5), and waits for delivery reservations from reception wishing users (step S22 in FIG. 6, and “delivery request/response” in FIG. 5). Upon receipt of delivery reservations from reception wishing users, multicast controller 1 delivers a decryption key to the reception wishing users from decryption key delivering means 12 (step S23 in FIG. 6).

After the delivery of the decryption key, multicast controller 1 communicates with position management server 4 on a periodic basis (“acquire position information” in FIG. 5) to count the number of reception wishing users in each of cells A, B with the aid of user number counting means 13 (step S24 in FIG. 6). If there are a given number of or more cells in which a given number of reception wishing users are present (step S25 in FIG. 6), multicast controller 1 requests delivery server 2 to deliver data, and start delivering the data from data delivering means 15 to these cells (step S26 in FIG. 6, and “deliver data” in FIG. 5). Upon start of the data delivery, multicast controller 1 charges the reception wishing users for the delivered contents with the aid of charging means 16 (step 27 in FIG. 6).

The foregoing multicast delivery system may be configured such that the user is allowed to confirm the number of reception wishing users in each cell on his own user terminal. This configuration will prompt users to move to and concentrate in a cell in which there are a larger number of reception wishing users, so that the system can further take advantage of the multicasting.

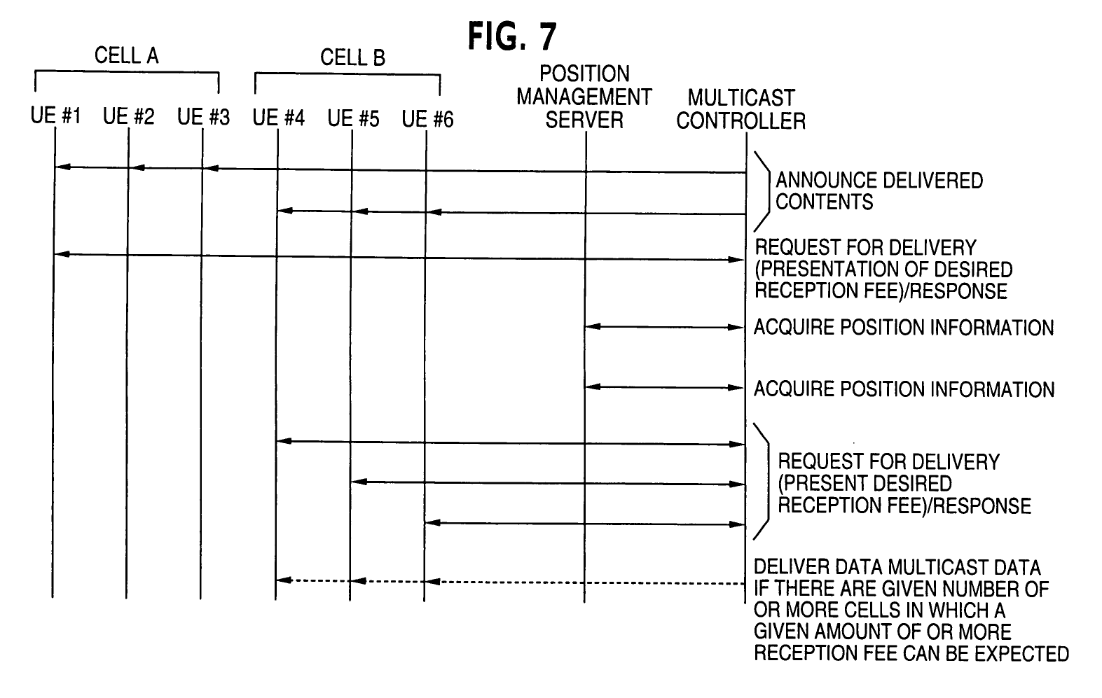

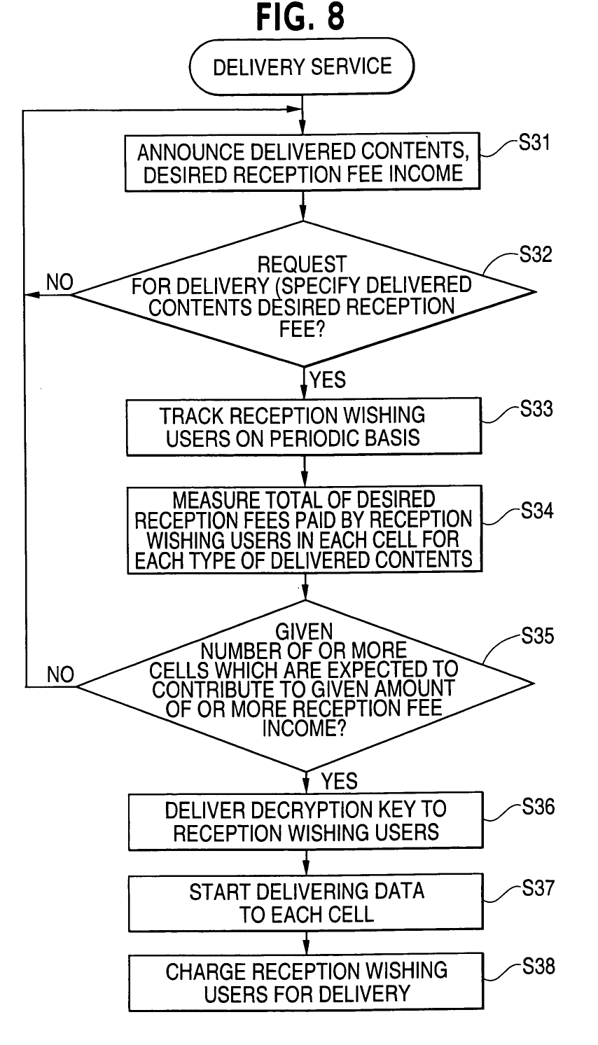

FIG. 7 is a sequence chart showing the operation of a multicast delivery system according to a further embodiment of the present invention, and FIG. 8 is a flow chart illustrating the operation of a multicast controller according to the further embodiment of the present invention. Likewise, since the multicast delivery system and multicast controller are basically identical in configuration to those illustrated in FIGS. 1 and 2, the following description will focus on characteristic operations in the multicast delivery with reference to FIGS. 1, 2, 7 and 8. Likewise, in this embodiment, the processing illustrated in FIG. 8 is implemented by control means 17 which executes a program on recording medium 18.

Auction sites on which articles are traded through the Internet are generally known. In such a site, a person who offers the highest price equal to or higher than a minimum bid price determined by an offerer for a certain article within a fixed period acquires the right of purchasing the article. The multicast delivery system according to this embodiment employs an auction site method as mentioned, wherein a reception wishing user can present a desired price.

Upon start of a delivery service, multicast controller 1 announces delivered contents, and a desired reception fee income, from delivery content announcing means 11 to each of cells A, B (step S31 in FIG. 8, and “announce delivered contents” in FIG. 7), and waits for delivery reservations from reception wishing users (step S32 in FIG. 8). In this event, a reception wishing user sends a delivery request to multicast controller 1, for example, by specifying the delivered contents and a desired reception fee specified by URL (Uniform Resource Locator) (“delivery request (presentation of desired reception fee)/response” in FIG. 7).

Upon receipt of the delivery request, multicast controller 1 communicates with position management server 3 on a periodic basis to track the reception wishing user (step S33 in FIG. 8, and “acquire position information” in FIG. 7), and measures a total of desired reception fees paid by reception wishing users in each of cells A, B, for example, for each type of delivered contents in user number counting means 13 (step S34 in FIG. 8). Next, if there are a given number of or more cells in which a given mount of reception fee income can be expected (step S35 in FIG. 8), multicast controller 1 delivers a decryption key to the reception wishing users from decryption key delivering means 12 at this time (step S36 in FIG. 8). Next, multicast controller 1 requests delivery server 2 to deliver data, and starts delivering data from data delivering means 15 to those cells (step S37 in FIG. 8). Then, upon start of the data delivery, multicast controller 1 charges the reception wishing users for the delivered contents with the aid of charging means 16 (step S38 in FIG. 8).

The foregoing multicast delivery system may be modified such that a user can confirm on his own user terminal a desired reception fee income presented by delivery server 2, and the total of desired reception fees presented by reception wishing users in each of cells A, B for each type of delivered contents, as well as the number of reception wishing users in each of cells A, B, while a delivery service provider can confirm on delivery server 2 the total of desired reception fees presented by reception wishing users in each of cells A, B. In this way, negotiations can be made between the users and delivery service provider in terms of the setting of reception fee, and the reception fee will be determined at an early stage to deliver data. When a new user wishes the reception in a cell in which the reception fee has been determined, data is delivered at the determined reception fee.

As described above, the multicast delivery system according to the present invention acquires information on reception and utilization of moving image and music data (the number of reception wishing users, the total of desired reception fees, and the like) within each cell based on delivery reservations from user terminals, and determines based on the acquired information whether or not a previously set delivery condition is satisfied, i.e., the condition in which the multicast delivery makes a profit. Then, moving image and music data is multicast only to those cells which contribute to profits. In this way, since data is delivered only to cells which contribute to profits, set communication expenses are ensured, thereby making it possible to multicast moving image and music data at a low charge.

The multicast delivery system in each of the embodiments described above may be modified such that multicast controller 1 transmits to reception wishing users within a cell which does not satisfy the delivery condition, a message stating that data is not delivered because the cell does not satisfy the delivery condition.

While preferred embodiments of the present invention have been described using specific terms, such description is for illustrative purposes only, and it is to be understood that changes and variations may be made without departing from the spirit or scope of the following claims.

1. A multicast controller for multicating moving image and music data supplied from a delivery server to a plurality of user terminals in a plurality of cells each defining a communication area, said controller comprising:
utilization information acquiring means for acquiring information on reception and utilization of the moving image and music data for one of the cells which contains said plurality of user terminals, based on a request received from each of said plurality of user terminals for delivering the moving image and music data;
delivery condition determining means for determining whether or not a previously set delivery condition is satisfied based on the reception and utilization information acquired by said utilization information acquiring means; and
data delivering means for multicasting the moving image and music data only to a cell which satisfies the delivery condition.

2. The multicast controller according to claim 1, wherein said utilization information acquiring means comprises means for counting the number of users who wish to receive the moving image and music data for the cell which contains said plurality of user terminals.

3. The multicast controller according to claim 2, wherein said delivery condition stipulates that a given number of reception wishing users exist within a single cell.

4. The multicast controller according to claim 2, wherein said delivery condition stipulates that there are a given number or more of cells in which a given number of reception wishing users exist.

5. The multicast controller according to claim 1, wherein said utilization information acquiring means comprises means for measuring a total of reception fees set by users who wish to receive the moving image and music data for the cell which contains said plurality of user terminals.

6. The multicast controller according to claim 5, wherein said delivery condition stipulates that there are a given number or more of cells which are expected to contribute to a reception fee income equal to or larger than a given amount.

7. The multicast controller according to claim 1, wherein said plurality of cells are cells of a third generation mobile communication network.

8. A multicast delivery system comprising:
a delivery server for delivering moving image and music data;
a plurality of user terminals contained in any of a plurality of cells each defining a communication area; and
a multicast controller for multicasting the moving image and music data supplied from said delivery server to said plurality of user terminals,
wherein said multicast controller comprises:
utilization information acquiring means for acquiring information on reception and utilization of the moving image and music data for one of the cells which contains said plurality of user terminals, based on a request received from each of said plurality of user terminals for delivering the moving image and music data;
delivery condition determining means for determining whether or not a previously set delivery condition is satisfied based on the reception and utilization information acquired by said utilization information acquiring means; and
data delivering means for multicasting the moving image and music data only to a cell which satisfies the delivery condition.

9. The multicast delivery system according to claim 8, wherein said utilization information acquiring means comprises means for counting the number of users who wish to receive the moving image and music data for the sell which contains said plurality of user terminals.

10. The multicast delivery system according to claim 9, wherein said delivery condition stipulates that a given number of reception wishing users exist within a single cell.

11. The multicast delivery system according to claim 9, wherein said delivery condition stipulates that there are a given number or more of cells in which a given number of reception wishing users exist.

12. The multicast delivery system according to claim 8, wherein said utilization information acquiring means comprises means for measuring a total of reception fees set by users who wish to receive the moving image and music data for the cell which contains said plurality of user terminals.

13. The multicast delivery system according to claim 12, wherein said delivery condition stipulates that there are a given number or more of cells which are expected to contribute to a reception fee income equal to or larger than a given amount.

14. The multicast delivery system according to claim 8, wherein said plurality of cells are cells of a third generation mobile communication network.

15. A multicast delivery method for multicating moving image and music data supplied from a delivery server to a plurality of user terminals in a plurality of cells each defining a communication area, said method comprising:
a first step of acquiring information on reception and utilization of the moving image and music data for one of the cells which contains said plurality of user terminals, based on a request received from each of said plurality of user terminals for delivering the moving image and music data;
a second step of determining whether or not a previously set delivery condition is satisfied based on the reception and utilization information acquired at the first step; and
a third step of multicasting the moving image and music data only to a cell which satisfies the delivery condition.

16. The multicast delivery method according to claim 15, wherein said first step includes counting the number of users who wish to receive the moving image and music data for the sell which contains said plurality of user terminals.

17. The multicast delivery method according to claim 16, wherein said delivery condition stipulates that a given number of reception wishing users exist within a single cell.

18. The multicast delivery method according to claim 16, wherein said delivery condition stipulates that there are a given number or more of cells in which a given number of reception wishing users exist.

19. The multicast delivery method according to claim 15, wherein said first step includes measuring a total of reception fees set by users who wish to receive the moving image and music data for the cell which contains said plurality of user terminals.

20. The multicast delivery method according to claim 19, wherein said delivery condition stipulates that there are a given number or more of cells which are expected to contribute to a reception fee income equal to or larger than a given amount.

21. The multicast delivery method according to claim 15, wherein said plurality of cells are cells of a third generation mobile communication network.

22. A program for use in a multicast controller for multicating moving image and music data supplied from a delivery server to a plurality of user terminals in a plurality of cells each defining a communication area, said program causing a computer of said multicast controller to execute:
first processing for acquiring information on reception and utilization of the moving image and music data for one of the cells which contains said plurality of user terminals, based on a request received from each of said plurality of user terminals for delivering the moving image and music data;
second processing for determining whether or not a previously set delivery condition is satisfied based on the reception and utilization information acquired by the first processing; and
third processing for multicasting the moving image and music data only to a cell which satisfies the delivery condition.
